(19) United States
(12) Patent Application Publication
(10) Pub. No.: US 2006/0187625 A1
(43) Pub. Date: Aug. 24, 2006

(54) Monitor apparatus

(75) Inventors: Jun-su Jung, Suwon si (KR); Shang-hun Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/247,232

(22) Filed: Oct. 12, 2005

(30) Foreign Application Priority Data
Feb. 22, 2005 (KR) 2005-0014499

(51) Int. Cl. G06F 1/16

(52) U.S. Cl. 361/681; 361/683; 248/917

(57) ABSTRACT

A monitor apparatus includes a monitor main body and a base member supporting the monitor main body. A link member is disposed between the monitor main body and the base member. A base hinge connects a first side of the link member and the base member to pivot the link member with respect to the base member and to support the link member and the base member to rearwardly pivot the link member with respect to the base member and to be unfolded in a surface direction of the base member. A monitor hinge connects the monitor main body and a second side of the link member to pivot the monitor main body with respect to the link member and to support the monitor main body and the link member to forwardly pivot the monitor main body with respect to the link member and to be folded with the base member. Thus, the monitor apparatus has an adjustable height and viewing angle of the monitor main body, thereby decreasing packaging size and distribution costs.

### CROSS-REFERENCE TO RELATED APPLICATIONS

This application claims the benefit under 35 U.S.C. § 119(a) of Korean Patent Application No. 2005-0014499, filed on Feb. 22, 2005, in the Korean Intellectual Property Office, the entire disclosure of which is hereby incorporated by reference.

### BACKGROUND OF THE INVENTION

1. Field of the Invention

The present invention relates to a monitor apparatus. More particularly, the present invention relates to a monitor apparatus having an improved tilting structure of a monitor with respect to a base member.

2. Description of the Related Art

As shown in FIG. 1, a conventional monitor apparatus includes a base member 201 stably seated on a predetermined surface, a monitor main body 202 adapted to display a picture thereon, and a connecting member 210 connecting the base member 201 and the monitor main body 202.

A lower end of the connecting member 210 is tiltably supported by a pair of base brackets 204 and 206 coupled to the base member 201. An upper end of the connecting member 210 is integrally coupled with the monitor main body 202.

Thus, the connecting member 210 may be tilted in upward and downward directions with respect to the base member 201, as shown in FIG. 1.

However, in the conventional monitor apparatus, the monitor main body 202 cannot be tilted with respect to the connecting member 210 such that the height and viewing angle of the monitor are not adjustable, thereby increasing the packaging size and distribution costs.

Accordingly, a need exists for an improved monitor apparatus in which both the height and viewing angle of the monitor main body are adjustable.

### SUMMARY OF THE INVENTION

Accordingly, it is an aspect of the present invention to provide a monitor apparatus to variously adjust height and a viewing angle of a monitor main body, thereby decreasing the packaging size and distribution costs.

Additional aspects and advantages of the present invention are set forth in part in the description that follows and, in part, will be obvious from the description, or may be learned by practice of the present invention.

The foregoing and other aspects of the present invention are also achieved by providing a monitor apparatus including a monitor main body and a base member supporting the monitor main body. A link member is disposed between the monitor main body and the base member. A base hinge connects a first side of the link member and the base member such that the link member is pivotable with respect to the base member and to support the link member and the base member such that the link member is rearwardly pivotable with respect to the base member and may be folded and unfolded in a surface direction of the base member. A monitor hinge connects the monitor main body and a second side of the link member to pivot the monitor main body with respect to the link member and to support the monitor main body and the link member to forwardly pivot the monitor main body with respect to the link member and to be folded with the base member.

According to an aspect of the present invention, the monitor apparatus further includes an auxiliary link member having a first side coupled to the base hinge and a second side coupled to the monitor hinge to transmit pivoting of the link member with respect to the base member to pivoting of the monitor main body.

According to an aspect of the present invention, the base hinge includes a base bracket coupled to the base member. A base hinge shaft connects the base bracket and the first side of the link member to pivot the link member with respect to the base bracket. A base spring member is disposed between the link member and the base bracket to backwardly press the link member around the base hinge shaft.

According to an aspect of the present invention, the monitor hinge includes a monitor bracket coupled to the monitor main body. A monitor hinge shaft connects the monitor bracket and the second side of the link member to pivot the monitor bracket with respect to the link member. A monitor spring member is disposed between the monitor bracket and the link member to backwardly press the monitor bracket around the monitor hinge shaft.

According to an aspect of the present invention, the monitor hinge includes a link support tiltably coupled with the second side of the link member, and coupled to the second side of the auxiliary link member to be eccentric to a pivot axis. A connecting member connects the link support and the monitor hinge shaft to transmit pivoting of the link support to pivoting of the monitor hinge shaft.

According to an aspect of the present invention, the first side of the auxiliary link member is coupled to the base bracket to be eccentric to a pivot axis of the base hinge shaft.

According to an aspect of the present invention, the monitor apparatus includes an auxiliary spring member having a first side coupled to the base bracket to be eccentric to a pivot axis of the base hinge shaft and a second side coupled to the link support to be eccentric to a pivot axis of the link support to press the link member in a backward tilting direction with respect to the base member.

According to an aspect of the present invention, the monitor apparatus includes a monitor bracket provided in the monitor hinge and pivotally coupled to the second side of the link member. A swivel hinge connects the monitor main body and the monitor bracket to swivel the monitor main body with respect to the monitor bracket.

According to an aspect of the present invention, the swivel hinge includes a swivel bracket coupled to the monitor main body. A swivel hinge shaft connects the swivel bracket and the monitor bracket to swivel the swivel bracket with respect to the monitor bracket.

According to an aspect of the present invention, the swivel hinge shaft has a cable penetrating part adapted to be penetrated by a cable connected to the monitor main body.

According to an aspect of the present invention, the swivel hinge includes a swivel angle limiter to limit a swivel angle of the swivel bracket with respect to the monitor bracket. The swivel angle limiter includes a swivel projection disposed in one of the monitor bracket and the swivel bracket. A stopper is disposed in the other one of the monitor bracket and the swivel bracket to limit pivoting of the swivel projection.

According to an aspect of the present invention, the base member includes a base extender that extends rearwardly further than a portion coupled to the base hinge.

According to an aspect of the present invention, the base hinge includes a base bracket coupled to the base member. The base extender extends rearwardly on both lateral sides of the base bracket.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other aspects and advantages of the present invention will become apparent and more readily appreciated from the following description of the embodiments, taken in conjunction with the accompanying drawings, in which:

FIG. 1 is a rear perspective view of a conventional monitor apparatus;

FIG. 2 is a rear perspective view of a monitor apparatus according to an exemplary embodiment of the present invention;

FIG. 3 is an exploded perspective view of the monitor apparatus of FIG. 2;

FIGS. 4 to 8 are side elevational views of sequential pivoted positions of a link member and a monitor main body of the monitor apparatus according to an exemplary embodiment of the present invention; and

FIGS. 9 and 10 are top plan views of rotated positions of the monitor main body of the monitor apparatus according to an exemplary embodiment of the present invention.

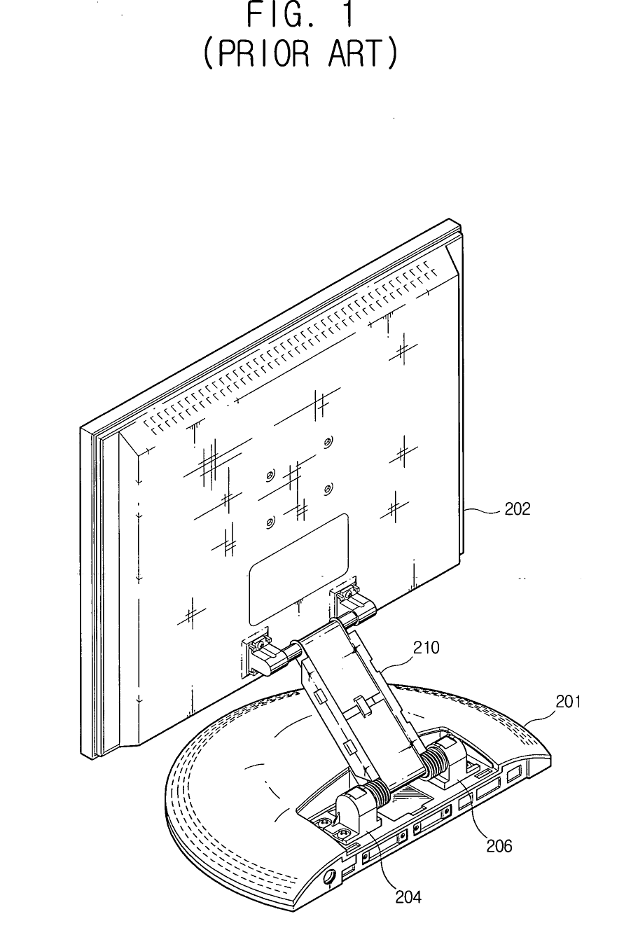

Throughout the drawings, like reference numerals will be understood to refer to like parts, components and structures.

### DETAILED DESCRIPTION OF EXEMPLARY EMBODIMENTS

Reference will now be made in detail to exemplary embodiments of the present invention, examples of which are illustrated in the accompanying drawings.

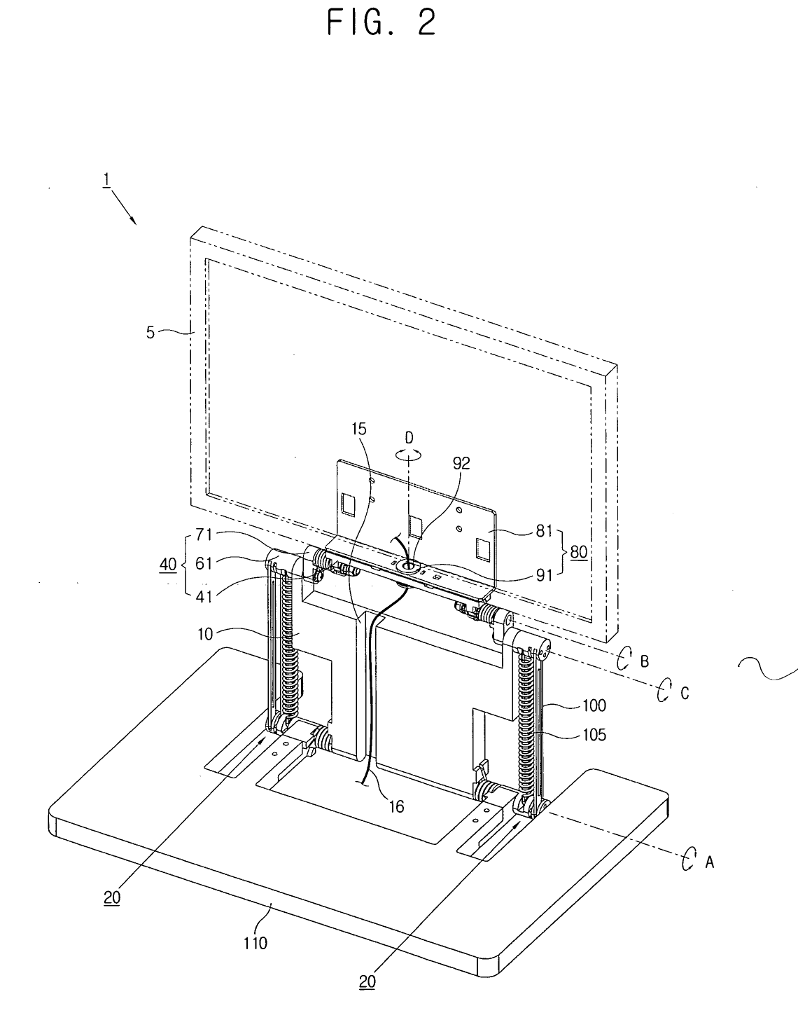

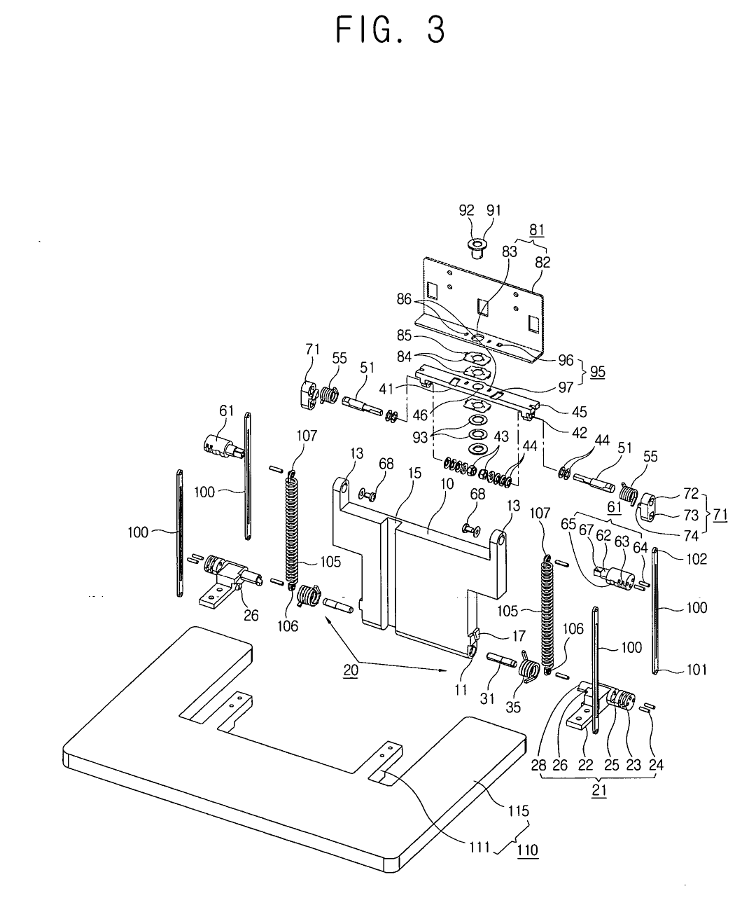

As shown in FIGS. 2 and 3, a monitor apparatus 1 according to an exemplary embodiment of the present invention includes a link member 10 disposed between a monitor main body 5 and a base member 110. A base hinge 20 pivotally connects a first end of the link member 10 and the base member 110 such that the link member 10 is pivotable with respect to the base member 110. A monitor hinge 40 pivotally connects the monitor main body 5 and a second end of the link member 10 such that the monitor main body 5 is pivotable with respect to the link member 10. The monitor apparatus 1 may further include an auxiliary link member 100 having a first end coupled to the base hinge 20 and a second end coupled to the monitor hinge 40, thereby being adapted to transmit pivoting of the link member 10 with respect to the base member 110 to pivoting of the monitor main body 5. The monitor apparatus 1 may further include a swivel hinge 80 rotatably connecting the monitor main body 5 and a monitor bracket 41 such that the monitor main body 5 rotates with respect to the link member 10.

The monitor main body includes a screen adapted to display an image thereon. The monitor main body 5 may include a thin display panel, such as a liquid crystal display (LCD) or a plasma display panel (PDP). The monitor main body 5 may be coupled to a swivel bracket 81 by a fastener, such as a screw.

The base member 110 is preferably shaped like a plate to be stably seated on a predetermined installation or support surface. The base member 110 includes a base bracket coupler 111 coupled with a base bracket 21. A base extender 115 extends from the base member 110, and is preferably parallel to the bracket coupler 111.

The base bracket couplers 111 are preferably provided as a spaced-apart pair connected to the base member 110, and are adapted to be coupled to the pair of base brackets 21 by a fastener, such as a screw.

The base extender 115 extends outwardly on both lateral sides of the base bracket coupler 111. Each base extender 115 is disposed adjacent each base bracket coupler 111, and extends beyond the base hinge 20. Thus, the link member 10 and the monitor main body 5 may be more safely supported by the base extender 115 when rearwardly pivoting the link member 10 and the monitor main body 5.

The link member 10 is preferably plate-shaped and has a predetermined thickness. Lower opposite sides of the link member 10 have a depressed base shaft accommodator 111 into which a first end of a base hinge shaft 31 is pivotally inserted with predetermined friction. Upper opposite sides of the link member 10 have a link support accommodator 13 adapted to pivotally receive a link support 61. The link member 10 has a first base spring supporter 17 adapted to support a first end of a base spring member 35, and a cable accommodator 15 adapted to accommodate a cable 16 connected to the monitor main body 5 and that transmits power and a picture signal to the monitor main body 5.

The base hinge 20 is coupled to the link member 10 and the base member 110 to pivot the link member 10 with respect to the base member 110 around a first horizontal axis (A). The base hinge 20 supports the link member 10 and the base member 110 to rearwardly pivot the link member 10 with respect to the base member 110 and to unfold the link member 10 from proximal a surface of the base member 110. The base hinge 20 includes the base bracket 21 coupled to the base member 110. The base hinge shaft 31 connect the base bracket 21 and the first end of the link member 10 to pivot the link member 10 with respect to the base bracket 21. The base spring member 35 is disposed between the link member 10 and the base bracket 21 to pivot the link member 10 around the base hinge shaft 31.

The base bracket 21 is disposed on opposite sides of the pair of base hinges 20. The base bracket 21 includes a base coupler 22 adapted to be coupled to the base bracket coupler 111 of the base member 11 by a fastener, such as a screw. A first auxiliary link accommodator 23 accommodates and supports the first end of the auxiliary link member 100. A first coupling pin 24 is coupled to a first pin coupler 101 of the auxiliary link member 100 inserted in the first auxiliary link accommodator 23 to pivotally couple the auxiliary link member 100 to the base bracket 21. A base shaft coupler 28 accommodates and couples to a second end of the base hinge shaft 31. A second base spring support 26 supports a second end of the base spring member 35. The base bracket 21 may further include a first auxiliary spring coupler 25 to support a first end of an auxiliary spring member 105.

The base hinge shaft 31 is preferably provided as a pair on opposite sides of the base hinge 20. The first end of the base hinge shaft 31 is pivotally coupled to the base shaft accommodator 11 of the link member 10. The second end of the base hinge shaft 31 is coupled to the base shaft coupler 28 of the base bracket 21.

The base spring member 35 is preferably provided as a pair on opposite sides of the base hinge 20. The base spring member 35 is preferably shaped like a torsion coil spring. The base spring member 35 provides elastic force to press the link member 10 in a rearwardly pivoting direction with respect to the base member 110. The first end of the base spring member 35 may be coupled to the first base spring support 17 of the link member 10, and the second end thereof may be coupled to the second base spring support 26 of the base bracket 21 to press the link member 10 in the rearward pivoting direction with respect to the base member 110 when the link member 10 is forwardly pivoted with respect to the base member 110.

The monitor hinge 40 is coupled to the monitor main body 5 and to the link member 10 to pivot the monitor main body 5 with respect to the link member 10 around a second horizontal axis (B). The monitor hinge 40 may support the monitor main body 5 and the link member 10 to forwardly pivot the monitor main body 5 with respect to the link member 10 and to fold the monitor main body 5 to the base member 110. The monitor hinge 40 includes a monitor bracket 41 coupled to the monitor main body 5. A monitor hinge shaft 51 couples the monitor bracket 41 to the second end of the link member 10 to pivot the monitor bracket 41 with respect to the link member 10. A monitor spring member 55 is disposed between the monitor bracket 41 and the link member 10 to rearwardly press the monitor bracket 41 around an axis of the monitor hinge shaft 51. The monitor hinge 40 may further include a link support 61 pivotally coupled to the second side of the link member 10 and eccentrically coupled with the second side of the auxiliary link member 100 with respect to a tilting axis. A connecting member 71 connects the link support 61 and the monitor hinge shaft 51 to transmit pivoting of the link support 61 to pivoting of the monitor hinge shaft 51.

The monitor bracket 41 is preferably bar-shaped and elongated horizontally. The monitor bracket 41 includes a monitor shaft accommodator 42 adapted to pivotally receive a first end of the monitor hinge shaft 51 with predetermined friction. A monitor shaft coupling member 43 is screw-coupled to a first end of the monitor hinge shaft 51 that penetrates the monitor shaft accommodator 42 to prevent the monitor hinge shaft 51 from being separated from the monitor shaft accommodator 42. Washers 44 provided on opposite sides of the monitor shaft accommodator 42 provide a predetermined friction force when pivoting the monitor bracket 41 with respect to the monitor hinge shaft 51. A first monitor spring support 45 supports the first end of the monitor spring member 55. The monitor bracket 41 may further include a swivel shaft accommodator 46.

The monitor shaft accommodator 42 is provided on opposite sides of the monitor bracket 41 to accommodate the monitor hinge shaft 51.

The monitor hinge shaft 51 is disposed on a pair of opposite sides of the monitor hinge 40. The first end of the monitor hinge shaft 51 is pivotally coupled to the monitor shaft accommodator 42 and a second end is coupled to a monitor shaft coupler 72 of the connecting member 71 having a non-circular shape.

The monitor spring member 55 is provided on opposite sides of the monitor hinge 40. The monitor spring member 55 is preferably shaped like a torsion coil spring and provides an elastic force to press the monitor main body 5 in a rearwardly tilting direction with respect to the link member 10. A first end of the monitor spring member 55 may be coupled to the first monitor spring support 45 of the monitor bracket 41 and a second end may be coupled to a second monitor spring support 74 of the connecting member 71 to press the monitor main body 5 in a rearwardly pivoting direction with respect to the link member 10 when the monitor main body 5 is forwardly tilted with respect to the link member 10.

The link support 61 is provided on opposite sides of the monitor hinge 40. The link support 61 includes a link hinge part 62 pivotally inserted in the link support accommodator 13 of the link member 10. A connecting member coupler 67 extends from a first end of the link hinge part 62 and is coupled to a link hinge coupler 73 of the connecting member 71. A link hinge connecting member 68 is coupled to a first end of the connecting member coupler 67 to prevent the connecting member coupler 67 from being separated from the connecting member 71. The link support 61 includes a second auxiliary link accommodator 63 to accommodate and support the second end of the auxiliary link member 100. A second coupling pin 64 is coupled to a second pin coupler 102 of the auxiliary link member 100 inserted in the second auxiliary link accommodator 63 to pivotally couple the auxiliary link member 100 to the link support 61. The link support 61 may further include a second auxiliary spring coupler 65 to support a second end of the auxiliary spring member 105.

The connecting member 71 is provided on opposite sides of the monitor hinge 40. The connecting member 71 includes the monitor shaft coupler 72 adapted to pivotally receive the second end of the monitor hinge shaft 51. The second monitor spring support 74 supports the second end of the monitor spring member 55. The link hinge coupler 73 is adapted to receive the connecting member coupler 67 of the link support 61. Thus, the connecting member 71 may transmit pivoting of the link support 61 to pivoting of the monitor hinge shaft 51.

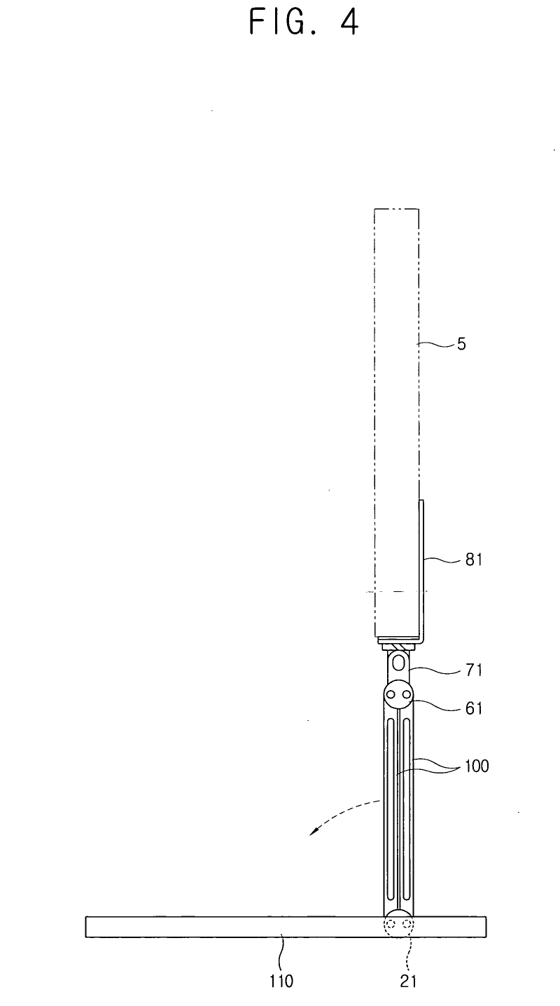

The auxiliary link member 100 is preferably shaped like a long bar, and a pair are disposed on each side of the link member 10. The first end of the auxiliary link member 100 has a first pin coupler 101 adapted to be coupled to the first auxiliary link accommodator 23 of the base bracket 21 by the first coupling pin 24, and is preferably eccentric with respect to the pivoting axis (A) of the base hinge 20. The second end of the auxiliary link member 100 has a second pin coupler 102 adapted to be coupled to the second auxiliary link accommodator 63 of the link support 61 by the second coupling pin 64, and is preferably eccentric with respect to the pivoting axis (C) of the link support 61. Thus, the auxiliary link member 100 is pivoted together with the link member 10 when the link member 10 is pivoted with respect to the base member 110, thereby pivoting the link support 61. The pivoting of the link support 61 pivotes the monitor main body 5 through the connecting member 71 and the monitor hinge shaft 51. The auxiliary link member 100 pivots the link support 61 to maintain a viewing angle with respect to the monitor main body 5 almost uniformly when pivoting the link member 10 (refer to FIGS. 4 to 7).

The monitor apparatus 1 further includes the auxiliary spring member 105, which has a first end coupled to the base bracket 21 and eccentric to a pivoting axis of the base hinge shaft 31 and a second end coupled to the link support 61 and eccentric to the pivoting axis of the link support 61, thereby biasing the link member 10 rearwardly with respect to the base member 110.

The auxiliary spring member 105 includes a first hook 106 on the first end and coupled to the first auxiliary spring coupler 25 of the base bracket 21 to be eccentric to the first axis (A). A second hook 107 on the second end is coupled to the second auxiliary spring coupler 65 of the link support 61 to be eccentric to the third axis (C). The auxiliary spring member 105 is preferably shaped like a coil spring and has an elastic force to stretch the first hook 106 and the second hook 107 in opposite directions from each other. Thus, the auxiliary spring member 105 may elastically press the link support 61 to allow the auxiliary link member 100 to more easily pivot the link support 61 when rearwardly pivoting the link member 10 with respect to the base member 110, and may be supportive to substantially prevent swinging or shaking of the link member 10 and the monitor main body 5 when pivoting the link member 10 and the monitor main body 5.

The swivel hinge 80 connects the monitor main body 5 and the monitor hinge 40 to swivel the monitor main body 5 around a fourth axis (D) in a vertical direction. The swivel hinge 80 includes a swivel bracket 81 coupled to the monitor main body 5. A swivel hinge shaft 91 connects the swivel bracket 81 and the monitor bracket 41 to swivel the swivel bracket 81 with respect to the monitor bracket 41. The swivel hinge 80 further includes a swivel angle limiter 95 to limit a swivel angle of the swivel bracket 81 with respect to the monitor bracket 41.

A first side of the swivel bracket 81 is coupled to the monitor main body 5. A second side of the swivel bracket 81 is coupled to the monitor bracket 41 by the swivel hinge shaft 91 to swivel with respect to one another. The swivel bracket 81 includes a main body coupler 82 coupled to the monitor main body 5 by a fastener, such as a screw. A swivel shaft coupler 83 is adapted to be penetrated by the swivel hinge shaft 91. A pair of sliding members 84 are provided between the swivel bracket 81 and the monitor bracket 41 to slide over each other without difficulty.

The pair of sliding members 84 are provided with a coupling projection 85 to be respectively coupled to the swivel bracket 81 and the monitor bracket 41. A projection accommodator 86 is disposed in the swivel bracket 81 and the monitor bracket 41 and accommodatingly supports the coupling projection 85 to swivel with the coupling projection 85. A center of the pair of sliding members 84 is penetrated by the swivel hinge shaft 91.

The swivel hinge shaft 91 is coupled to the swivel bracket 81 and the monitor bracket 41 in a vertical direction to swivel the monitor main body 5. Opposite ends of the swivel hinge shaft 91 are externally bent to prevent from being separated from the swivel bracket 81 and the monitor bracket 41. A plurality of washers 93 are disposed on the swivel hinge shaft 91 to generate a predetermined friction force when the swivel bracket 81 and the monitor bracket 41 are swiveled with respect to each other. A cable penetrating part 92 in the swivel hinge shaft 91 is adapted to be penetrated by a cable 16 connected to the monitor main body 5. Thus, the monitor apparatus 1 according to an exemplary embodiment of the present invention may accommodate the cable 16 connected to the monitor main body 5 through the cable penetrating part 92 of the swivel hinge shaft 91 and the cable accommodator 15 of the link member 10 to substantially prevent exposing the cable to the outside.

The swivel angle limiter 95 includes a swivel projection 96 provided in one of the monitor bracket 41 and the swivel bracket 81, and a stopper 97 provided in the other one of the monitor bracket 41 and the swivel bracket 81, thereby limiting swiveling of the swivel projection 96. As an example, the swivel projection 96 is provided in the swivel bracket to be projected toward the monitor bracket 41. The stopper 97 is cut out in the monitor bracket 41. The swivel projection 96 is integrally swiveled with the swivel bracket 81 with respect to the monitor bracket 41. The stopper 97 may preferably limit the swiveling of the swivel projection 96 in the range of approximately 0 to 180 degrees. Alternatively, the stopper 97 may limit the swiveling of the swivel projection 96 in the range of approximately 0 to 360 degrees.

With this configuration, the operation process of the monitor apparatus 1 according to an exemplary embodiment of the present invention is described in the following paragraphs with reference to FIGS. 4 through 10.

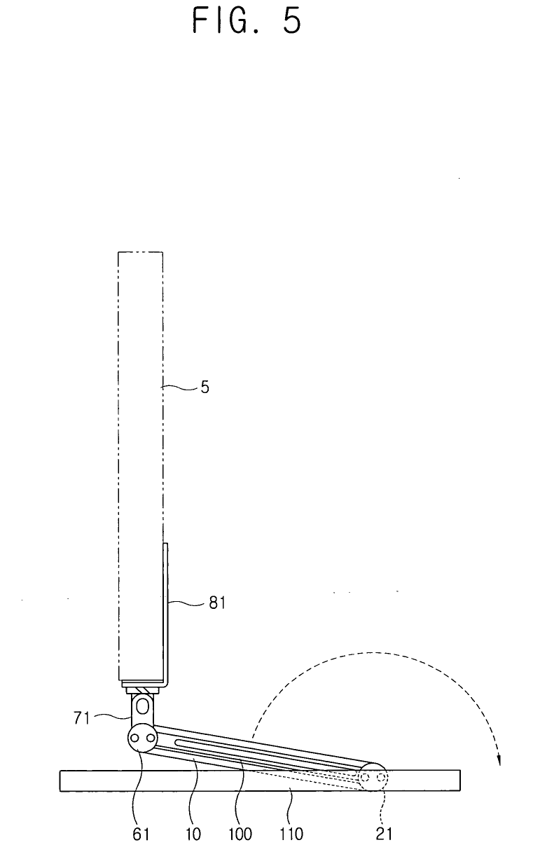

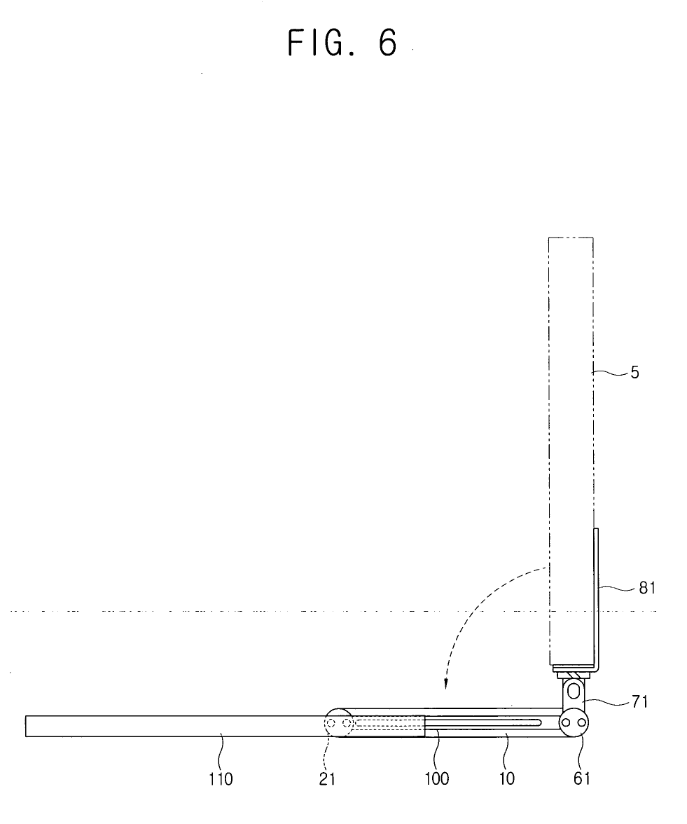

First, a user may tilt the link member 10 from the position shown in FIG. 4 to the positions shown in FIGS. 5 and 6. Thus, the monitor apparatus 1 according to an exemplary embodiment of the present invention may make the link member 10 to be tilted around the first axis (A), thereby adjusting the height of the monitor main body 5. When tilting the link member 10, the monitor main body 5 may maintain an almost uniform viewing angle, as shown in FIGS. 4-6. Also, the monitor apparatus 1 according to an exemplary embodiment of the present invention the auxiliary spring member 105 may make the auxiliary link member 100 pivot more easily pivot about the link support 61 when rearwardly pivoting the link member 10.

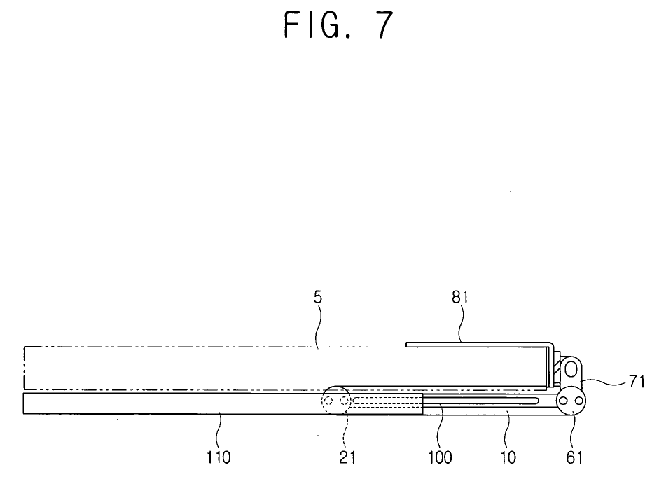

As shown in FIG. 7, the monitor main body 5 may be pivoted to be substantially parallel to the base member 110 from the position shown in FIG. 6. Thus, the monitor apparatus 1 according to an exemplary embodiment of the present invention allows the monitor main body 5 to be folded proximal to the base member 110, thereby reducing the packaging size of the monitor apparatus 1 and distribution costs.

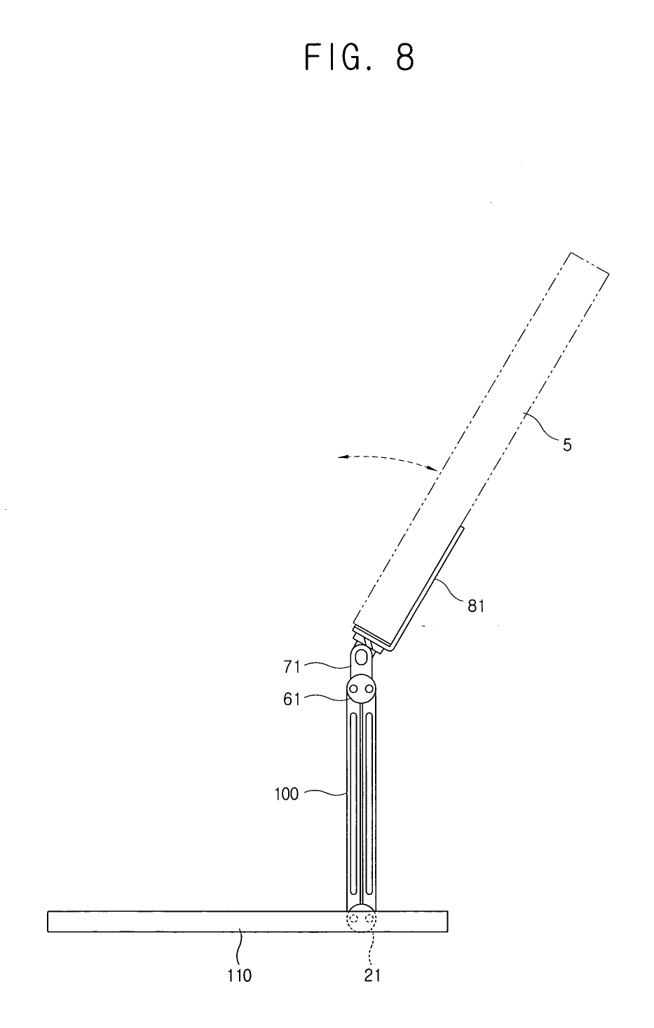

As shown in FIG. 8, the monitor main body 5 may be pivoted around the monitor hinge shaft 51 with respect to the link member 10. That is, the monitor main body 5 may be pivoted around the monitor hinge shaft 51 while the link member 10 is not pivoted (substantially perpendicular to the base member 110, as shown in FIG. 8).

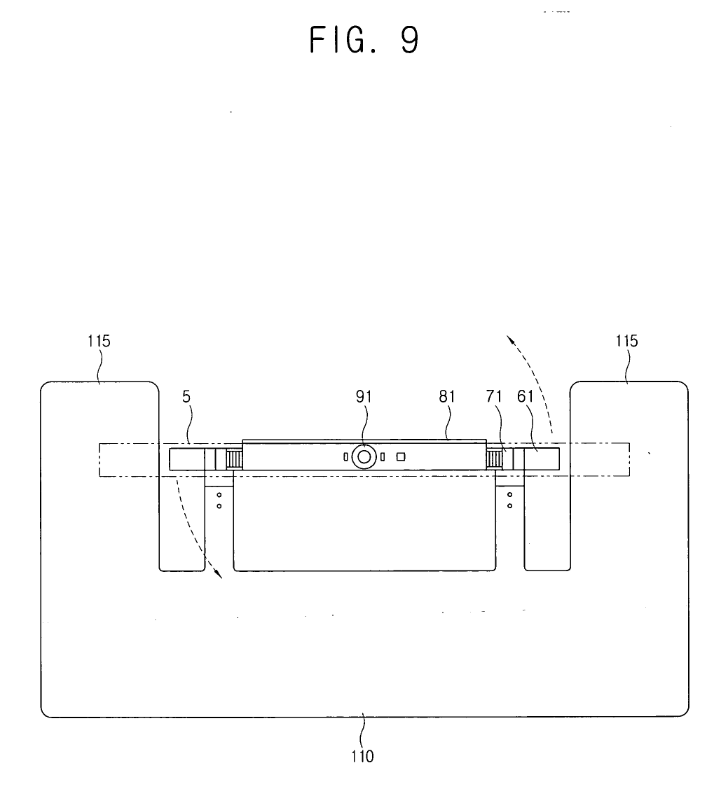

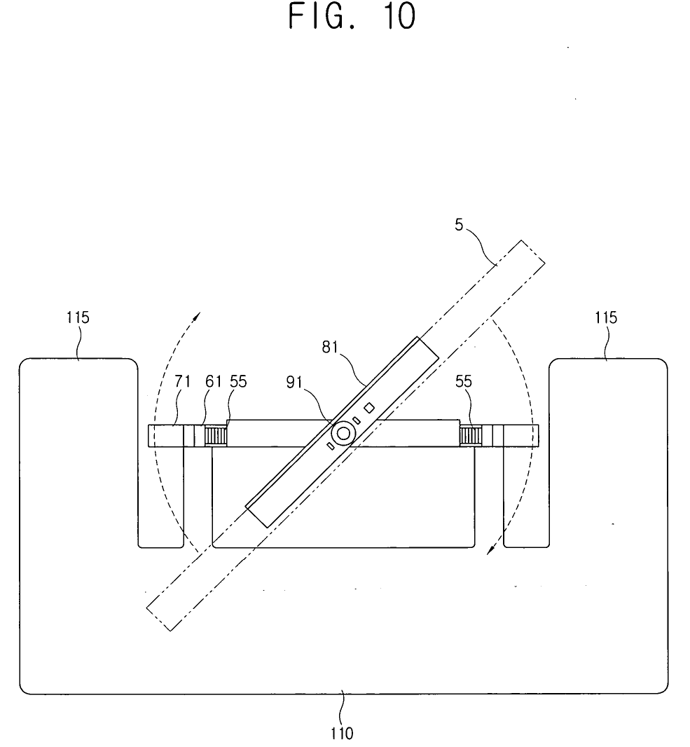

As shown in FIGS. 9 and 10, the monitor main body 5 may be swiveled around the swivel hinge shaft 91 with respect to the link member 10. Thus, the monitor apparatus 1 according to an exemplary embodiment of the present invention allows the monitor main body 5 not only to be pivoted with respect to the horizontal axes (A) and (B) but also to be swiveled with respect to the vertical axis (D), thereby providing various viewing angles for a user.

Also, the monitor apparatus 1 according to an exemplary embodiment of the present invention may support the link member 10 and the monitor main body 5 more safely when rearwardly tilting the link member 10 and the monitor main body 5 by the base extender 115.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A monitor apparatus having a monitor main body and a base member supporting the monitor main body, comprising:
a link member disposed between the monitor main body and the base member;
a base hinge pivotally connecting a first end of the link member to the base member to pivot the link member with respect to the base member and to support the link member and the base member when rearwardly pivoting the link member with respect to the base member and to pivot proximal to the base member; and
a monitor hinge pivotally connecting the monitor main body and a second end of the link member to pivot the monitor main body with respect to the link member and to support the monitor main body and the link member when forwardly pivoting the monitor main body with respect to the link member and to pivot with the base member.

2. The monitor apparatus according to claim 1, wherein
an auxiliary link member has a first end coupled to the base hinge and a second end coupled to the monitor hinge to transmit pivoting of the link member with respect to the base member to pivoting of the monitor main body.

3. The monitor apparatus according to claim 2, wherein
the base hinge includes a base bracket coupled to the base member;
a base hinge shaft is connected to the base bracket and the first end of the link member to pivot the link member with respect to the base bracket; and
a base spring member is disposed between the link member and the base bracket to rearwardly press the link member around the base hinge shaft.

4. The monitor apparatus according to claim 3, wherein
the monitor hinge includes a monitor bracket coupled to the monitor main body;
a monitor hinge shaft is connected to the monitor bracket and the second end of the link member to pivot the monitor bracket with respect to the link member; and
a monitor spring member is disposed between the monitor bracket and the link member to rearwardly press the monitor bracket around the monitor hinge shaft.

5. The monitor apparatus according to claim 4, wherein
the monitor hinge includes a link support pivotally coupled to the second side of the link member and coupled to the second end of the auxiliary link member to be eccentric to a pivoting axis; and
a connecting member is connected to the link support and the monitor hinge shaft to transmit pivoting of the link support to pivoting of the monitor hinge shaft.

6. The monitor apparatus according to claim 5, wherein
the first end of the auxiliary link member is coupled to the base bracket to be eccentric to a pivoting axis of the base hinge shaft.

7. The monitor apparatus according to claim 6, wherein
an auxiliary spring member has a first end coupled to the base bracket to be eccentric to a pivoting axis of the base hinge shaft, and a second end is coupled to the link support to be eccentric to a pivoting axis of the link support to press the link member in a rearwardly pivoting direction with respect to the base member.

8. The monitor apparatus according to claim 1, wherein
a monitor bracket is connected to the monitor hinge and pivotally coupled to the second end of the link member; and
a swivel hinge is connected to the monitor main body and the monitor bracket to swivel the monitor main body with respect to the monitor bracket.

9. The monitor apparatus according to claim 8, wherein
the swivel hinge includes a swivel bracket coupled to the monitor main body; and
a swivel hinge shaft is connected to the swivel bracket and the monitor bracket to swivel the swivel bracket with respect to the monitor bracket.

10. The monitor apparatus according to claim 9, wherein
the swivel hinge shaft has a cable penetrating part adapted to receive a cable connected to the monitor main body.

11. The monitor apparatus according to claim 9, wherein
the swivel hinge includes a swivel angle limiter to limit a swivel angle of the swivel bracket with respect to the monitor bracket;and
the swivel angle limiter includes a swivel projection provided in one of the monitor bracket and the swivel bracket, and a stopper provided in the other one of the monitor bracket and the swivel bracket to limit swiveling of the swivel projection.

12. The monitor apparatus according to claim 1, wherein
the base member includes a base extender extending rearwardly further than than a portion of the base member to which the base hinge is coupled.

13. The monitor apparatus according to claim 12, wherein
the base hinge includes a base bracket coupled with the base member, and the base extender extends rearwardly on both lateral sides of the base bracket.

14. A method of adjusting a monitor apparatus, comprising the steps of
pivoting a link member disposed between the monitor main body and the base member about a first horizontal axis;
pivoting the monitor main body about a second horizontal axis; and
pivoting the monitor main body about a third horizontal axis to adjust a viewing angle of the monitor main body.

15. The method of adjusting a monitor apparatus according to claim 14, further comprising
pivoting the link member about the first horizontal axis until the link member is substantially parallel to the base member.

16. The method of adjusting a monitor apparatus according to claim 15, further comprising
pivoting the monitor main body about the second horizontal axis until the monitor main body is substantially proximal to the base member.

17. The method of adjusting a monitor apparatus according to claim 14, wherein
the link member is pivotable about the first horizontal axis and the monitor main body is pivotable about the second horizontal axis independently of each other.

18. The method of adjusting a monitor apparatus according to claim 14, wherein
the monitor main body is independently pivotable about the second and third horizontal axes.

19. The method of adjusting a monitor apparatus according to claim 14, further comprising
swiveling the monitor main body about a first vertical axis to adjust a viewing angle of the monitor main body.

20. The method of adjusting a monitor apparatus according to claim 19, wherein
the monitor main body is rotatable around the first vertical degrees for approximately 360 degrees.
